(19) United States
(12) Patent Application Publication
(10) Pub. No.: US 2021/0256870 A1
(43) Pub. Date: Aug. 19, 2021

(54) COLOR CHANGING MICTURITION TRAINING COMPOSITION AND PROCESS FOR USE THEREOF

(71) Applicant: POTTY MAGIC LLC, Beverly Hills, MI (US)

(72) Inventors: Shaowen Ji, Beverly Hills, MI (US); Palavi Bapat, Beverly Hills, MI (US); Evan Boyst, Beverly Hills, MI (US); James Dankovich, Beverly Hills, MI (US)

(73) Assignee: POTTY MAGIC LLC, Beverly Hills, MI (US)

(21) Appl. No.: 16/789,484

(22) Filed: Feb. 13, 2020

(51) Int. Cl. G09B 19/00; G09B 5/02; G01N 31/22

(52) U.S. Cl. CPC G09B 19/0076; G01N 31/221; G09B 5/02; G09B 19/0023

(57) ABSTRACT

A process of toilet training a subject to encourage urination in a toilet. Urease and color changing first pH indicator are introduced into water a toilet bowl of the toilet. In the presence of urine in the water the urease reacts with the urine to create a by-product that causes the color changing first pH indicator to change to a first color at a first pH thereby encouraging the subject to urinate in the toilet. A composition is provided that includes urease, color changing first pH indicator an excipient comprising citric acid, a binder, or a combination thereof. A kit is provided for the composition, a container for the composition, and instructions for using the composition during toilet training.

### FIELD OF THE INVENTION

The present invention in general relates to compositions, kits, and processes of use thereof for micturition training, and in particular to a color changing micturition training composition, kit, and process of use thereof for providing amusement to a micturition trainee and for encouraging a micturition trainee to urinate in a toilet bowl.

### BACKGROUND OF THE INVENTION

Micturition training is an inevitable part of child development. The process is often difficult and stressful for parents and children alike. Children are often not motivated to engage in micturition training given the relative ease of, and comfort with superabsorbent diaper useage. Children can also be intimidated by the micturition training process. Parents are often frustrated by a child's lack of interest and/or slow progress in micturition training. A child's repeated failure to use a toilet may cause a parent to force a child to attempt to use a toilet, even when the child does not have the urge to do so. This behavior can be counterproductive as it may exacerbate a child's aversion to micturition training for a number of reasons illustratively including stoking fear in the child (e.g. fear of angering/disappointing the parent, fear of failure, etc.), casting a negative light on an already intimidating process, and further encouraging disengagement in the micturition training process altogether.

A variety of micturition training solutions are known to the art. Complex mechanical micturition training solutions which move or otherwise provide engagement stimuli in response to toilet use have been developed. Complex electrical micturition training solutions that provide light or sonic stimulation in response to toilet use have also been developed. Such solutions are generally difficult to maintain and prone to failure given their intended location for use where exposure to water, human waste, microbes, and repeated vibrational and/or physical disruption caused by the opening and closing of a toilet lid and/or toilet seat can readily cause mechanical and electrical disruption. Such solutions are also generally too complex for mainstream adoption.

Other prior art micturition training solutions target just one gender, illustratively males. These solutions often employ a form of target game in an attempt to foster engagement with the micturition training process. With this prior art solution, boys can attempt to hit a target situated in a toilet bowl or move constituent pieces floating in the toilet water toward a goal. Such solutions have the drawback of only being useful for approximately half of the micturition trainee population and therefore are also not viable for mainstream use.

Thus, there exists a need for a simple micturition training composition, kit, and process of use thereof that imparts positive micturition training feedback stimulus to a micturition trainee who experiences amusement and satisfaction upon observing a color change after micturating in a toilet bowl, thereby encouraging micturition trainee engagement, and motivating a micturition trainee to repeatedly urinate into a toilet bowl.

### SUMMARY OF THE INVENTION

A process of toilet training a subject to encourage urination in a toilet. Urease and color changing first pH indicator are introduced into water a toilet bowl of the toilet. In the presence of urine in the water the urease reacts with the urine to create a by-product that causes the color changing first pH indicator to change to a first color at a first pH thereby encouraging the subject to urinate in the toilet.

A process for color changing micturition training is also provided that includes at least one of watching an online motivational video or reading a motivational booklet, the online motivational video and the motivational booklet both explaining to a subject that water in a toilet bowl will change color after the trainee urinates into a toilet bowl, motivating the subject to urinate into the toilet bowl by fostering a positive mental association between anticipation and amusement of watching a color change upon micturating into the toilet bowl, adding an inventive color changing micturition training composition to the water in the toilet bowl, micturating into the toilet bowl, observing the color change in the water upon contact with urine, imparting positive micturition training feedback stimulus to the micturition trainee experiencing amusement and satisfaction upon observing the color change after micturating into the water in the toilet bowl, and encouraging regular urination into the toilet bowl.

A composition is provided that includes urease, color changing first pH indicator an excipient comprising citric acid, a binder, or a combination thereof. A color changing micturition training composition is provided that includes urease present from 35 to 45 total weight percent, a color changing pH indicator present from 1 to 5 total weight percent, a desiccant present from 10 to 20 total weight percent, and an excipient present from 35 to 45 total weight percent.

A kit is provided for the composition, a container for the composition, and instructions for using the composition during toilet training.

A kit for color changing micturition training is also provided that includes an inventive color changing micturition training composition and instructions for using an inventive color changing micturition training composition during color changing micturition training, and packaging containing an inventive composition in a delivery medium and the instructions.

These and other features of the inventive color changing micturition training composition, kit, and process of use thereof will become apparent from the following detailed description which is exemplary and not limiting of the appended claims.

### DETAILED DESCRIPTION OF THE INVENTION

The present invention has utility as a color changing micturition training composition that is added to toilet water in a toilet bowl. The inventive composition changes color upon coming into contact with urine. The color change confers a positive micturition training feedback stimulus to a micturition trainee who experiences amusement upon observing the color change after micturating into a toilet bowl. This positive micturition training feedback stimulus encourages engagement in the micturition training process and motivates the micturition trainee to continue to urinate into the toilet bowl. In some inventive embodiments, the inventive composition also changes color upon being added to water in a toilet bowl. It is appreciated that the color change upon being added to water in a toilet bowl is a different color change than that observed upon coming into contact with urine. It is also appreciated that this inventive embodiment fosters further engagement with the micturition training process as the micturition trainee experiences initial amusement upon observing the first of two color changes upon addition of an inventive composition to water in the toilet bowl, and then further amusement upon observing the second color change after successfully micturating into the toilet bowl.

The present invention also has utility as a kit for color changing micturition training that includes an inventive composition in a delivery medium, instructions for using an inventive composition during color changing micturition training, and packaging containing an inventive composition in a delivery medium and the instructions. In embodiments, the instructions are a motivational booklet that explains to a micturition trainee that water in the toilet bowl will change color after the trainee urinates into the toilet bowl. In some embodiments the instructions may also include directions for locating and viewing an online motivational video that explains to a micturition trainee that water in toilet bowl will change color after the trainee urinates into the toilet bowl. In inventive embodiments, the online motivational video is a cartoon designed to instill excitement and motivation in the micturition trainee in order to increase engagement and ultimate success in the micturition training by the micturition trainee. In other inventive embodiments, it is appreciated that the online motivational video includes live actors. In some inventive embodiments, it is appreciated that the online motivational video is in documentary format. In still other inventive embodiments, it is appreciated that the online motivational video is a blend of cartoon and live acting, as separate segments, as live actors overlaid onto a cartoon backdrop using technology known to the art illustratively including green screen technology, or combinations thereof.

The present invention has further utility as a process for color changing micturition training. The inventive process motivates the micturition trainee to urinate into the toilet bowl by fostering a positive mental association between anticipation and amusement of watching a color change upon micturating into water in a toilet bowl that has an inventive composition therein. The inventive process also imparts positive micturition training feedback stimulus to the micturition trainee experiencing amusement and satisfaction upon observing the color change after micturating into the water in a toilet bowl containing an inventive composition therein. This positive micturition training feedback stimulus encourages regular urination into the toilet bowl, and successful completion of micturition training.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The suffix “(s)” as used herein is intended to include both the singular and the plural of the term that it modifies, thereby including one or more of that term.

Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable.

An inventive color changing micturition training composition includes enzymatically active urease in combination with a color changing pH indicator responsive to the pH enzymatic cleavage product. Other components are added to facilitate manufacture, shelf life, or enhance usage.

Also considered as equivalents of urease purposes of this invention is urease produced by rDNA manipulation on the basis of genetic material corresponding to a urease, with or without modifications. Also, within the scope of the invention as equivalent to the use of the proteases mentioned above is the use of analogues (e.g. analogues made by mutant organisms) and derivatives and conjugates of the urease. By way of example, a synthetic protein that is a truncate or point mutant relative to urease is operative herein so long as the function of native urease is maintained as to the reaction:

(NH₂)₂CO+H₂O→CO₂+2NH₃ (I)

Urease has a well known in terms of primary through quaternary structure regardless of the source as to whether derived from plant, bacteria, of fungal source. Sequences and structures are illustratively detailed in EC 3.5.1.5 and NP_176922.1 (Arabidopsis thaliana).

“Urease” is meant to define a polypeptide or fragment thereof having at least about 85% amino acid identity to EC 3.5.1.5, and having the ability to complete reaction I at greater than 8% of the rate of the native urease under like conditions.

The urease defined above is included according to the present invention in an amount of 0.1 to 500 Units/mg of inventive composition. A Unit, which is defined as the proteolytic enzyme activity which, under standard conditions, during a 15-minute-incubation at 40 deg C., with urea as substrate, produces an amount of ammonia equivalent to 1 micromole of urea.

Modifications and changes are optionally made in the structure (primary, secondary, or tertiary) of urease which are encompassed within the inventive compound that may or may not result in a molecule having similar characteristics to the exemplary polypeptides disclosed herein. It is appreciated that changes in conserved amino acid bases are most likely to impact the activity (I) of the resultant urease. Certain amino acid substitutions for other amino acids in a sequence are known to occur without appreciable loss of activity.

In making such changes, the hydropathic index of amino acids are considered. According to the present invention, certain amino acids can be substituted for other amino acids having a similar hydropathic index and still result in a polypeptide with similar biological activity. Each amino acid is assigned a hydropathic index on the basis of its hydrophobicity and charge characteristics. Those indices are: isoleucine (+4.5); valine (+4.2); leucine (+3.8); phenylalanine (+2.8); cysteine/cysteine (+2.5); methionine (+1.9); alanine (+1.8); glycine (−0.4); threonine (−0.7); serine (−0.8); tryptophan (−0.9); tyrosine (−1.3); proline (−1.6); histidine (−3.2); glutamate (−3.5); glutamine (−3.5); aspartate (−3.5); asparagine (−3.5); lysine (−3.9); and arginine (−4.5).

Without intending to be limited to a particular theory, it is believed that the relative hydropathic character of the amino acid determines the secondary structure of the resultant polypeptide, which in turn defines the interaction of the polypeptide with other molecules. It is known in the art that an amino acid can be substituted by another amino acid having a similar hydropathic index and still obtain a functionally equivalent polypeptide. In such changes, the substitution of amino acids whose hydropathic indices are within ±2 is preferred, those within .+−0.1 are particularly preferred, and those within ±0.0.5 are even more particularly preferred.

As outlined above, amino acid substitutions are generally based on the relative similarity of the amino acid side-chain substituents, for example, their hydrophobicity, hydrophilicity, charge, size, and the like. Exemplary substitutions that take various of the foregoing characteristics into consideration are well known to those of skill in the art and include (original residue: exemplary substitution): (Ala: Gly, Ser), (Arg: Lys), (Asn: Gln, His), (Asp: Glu, Cys, Ser), (Gln: Asn), (Glu: Asp), (Gly: Ala), (His: Asn, Gln), (Ile: Leu, Val), (Leu: Ile, Val), (Lys: Arg), (Met: Leu, Tyr), (Ser: Thr), (Thr: Ser), (Tip: Tyr), (Tyr: Trp, Phe), and (Val: Ile, Leu).

A typical inventive composition has a pH indicator present from 1 to 5 total weight percent of the inventive composition, a desiccant present from 0 to 20 total weight percent of the inventive composition, and urease present from 1 to 45 total weight percent of the inventive composition, and the remainder being excipients.

Table 1 shows a training composition according to the present invention with material amounts as weight percentages to the composition unless stated otherwise.

TABLE 1
Training composition with amounts provided as total weight
percentages of the training composition. It is appreciated
that such formulations are dispersed in solvents.

| Component | Typical (%) | Preferred (%) |
|---|---|---|
| pH indicator | 1-5 | 1-3 |
| Dessicant | 0-20 | 10-20 powder, |
| | | 0 solution |
| Urease | 1-45 | 35-45 |
| Excipients | Remainder | Remainder |
| Total | 100% | 100% |

It is appreciated that the present invention is prepared as a dessicated powder or an aqueous solution with still maintaining urease activity.

In embodiments of the present invention the color changing pH indicator changes from an initial color to a second color at a pH range of between 6.5 and 10. The term pH refers to the concentration of hydrogen ions (pH=−log [H⁺]). Neutral pH value is 7.0. Lower values represent acidic solutions while pH values higher than 7.0 represent alkaline solutions. Urease activation begins at a medium pH of 6.5 and reaches its maximum value at pH 5.5. Urease activity remains constant down to a pH between 2.5 and 3.0 and is detectable even at a pH of 2.0, it is noted that urease activity increases pH due release of ammonia per equation (I). In embodiments of the present invention the color changing pH indicator changes from an initial color to a second color upon contact with urine. The pH of urine can range from 4.5 to 8.0, with an average pH value of 6.0. The pH of water can range from 6.5 to 8.5. It is appreciated that because of the density difference between urine and water, urine and water in a toilet bowl do not readily mix. Thus, the color changing pH indicator of the inventive composition undergoes a color change at the pH ranges described herein upon contact with urine which lowers the pH relative to the pH of the water in the toilet bowl. In some embodiments of an inventive composition a second color changing indictor is included that changes from an initial color to a second color upon contact with water. It is appreciated that the second color of the second color changing indicator is different than the second color of the color changing pH indicator. In embodiments of an inventive composition, the color changing first pH indicator is clear prior to undergoing a color change at the pH ranges described herein upon contact with urine. In some embodiments of an inventive composition, the color changing first pH indicator color changes to a second color of blue at the pH ranges described herein upon contact with urine.

In embodiments, the color changing pH indicator, and if present, the second color changing indicator of an inventive composition, kit, and process described herein are at least one of: carmine, carminic acid, curry powder, thymol blue, pentamethoxy red, tropaeolin O, tropaeolin OO, tropaeolin OOO, 2, 4-dinitrophenol, methyl yellow, methyl orange, bromophenol blue, tetrabromophenol blue, alizarin sodium sulfonate, alpha-naphthyl red, para-ethoxychrysoidine, bromocresol green, methyl red, bromocresol purple, chlorophenol red, bromothymol blue, para-nitrophenol, azolitmin, phenol red, neutral red, rosolic acid, cresol red, naphtholphthalein, phenolphthalein, naphtholbenzein, thymolphthalein, nile blue, alizarin yellow, salicyl yellow, diazo violet, nitramine, poirrier's blue, trinitrobenzoic acid, extracts from: beets, blackberries, blueberries, carrots, cherries, delphinium petals, geranium petals, grapes, grape seeds, horse chestnut leaves, morning glories, pansy petals, petunia petals, primrose, poppy petals, purple peonies, red radish, red cabbage, rhubarb, rose petals, strawberries, tea, turmeric, tulip petals, thyme, violet petals, vanilla, a thermosensitive dye, an oxygen sensitive dye, or a combination comprising at least one of the foregoing. In an inventive embodiment, the color changing pH indicators are bromocresol green and chlorophenol red, and the excipients are citric acid monohydrate and water.

In an embodiment of the inventive composition the excipient is citric acid monohydrate. In other inventive embodiments the excipient is at least one of a binder including, but not limited to, saccharides and their derivatives illustratively including: sucrose, lactose, starches, cellulose or modified cellulose such as microcrystalline cellulose, cellulose ethers such as hydroxypropyl cellulose, xylitol, sorbitol, mannitol, gelatin, synthetic polymers illustratively including polyvinylpyrrolidone (PVP) and polyethylene glycol (PEG), a coating illustratively including hydroxypropyl methylcellulose, shellac, zein, and gelatin, a disintegrant illustratively including crosslinked polyvinylpyrrolidone, crosslinked sodium carboxymethyl cellulose, and sodium starch glycolate, a preservative illustratively including vitamins A, E, and C, retinyl palmitate, selenium, cysteine, methionine, citric acid, sodium citrate, and a paraben, a vehicle illustratively including petrolatum, dimethyl sulfoxide, water, mineral oil, and polyvinyl alcohol, or a combination including at least one of the foregoing.

In certain inventive embodiments, the composition is packaged as a liquid, a powder, capsule, or a gel. It is appreciated that in some inventive embodiments, the constituent(s) of the excipient will be largely determinative as to whether the inventive composition is a liquid, a powder, a capsule, or a gel. In some inventive embodiments, the composition is a powder that is formed into a water-dissolvable tablet. In other inventive embodiments, the composition is a gel formed into a gel pod with a water-soluble barrier film. Gelatin and polyacrylic acid are exemplary of such water-soluble barrier films. In other inventive embodiments, it is appreciated that the tablet and/or gel pod are formed in a fanciful or representative shape of as at least one of: an animal, a plant, a flower, food items, clothing, a cartoon character, a storybook or fictional character, a letter, a number, an automobile, a truck, an airplane, a boat, a train, a bicycle, a wagon, a toy, a ball or other sporting apparatus, a hammer or other tool, a geometric shape, a planet or other celestial object, a musical instrument, or a combination of at least one of the foregoing. It is appreciated that the shapes described herein offer further encouragement and motivation to a micturition trainee to engage in the micturition training process as these shapes instill feelings of familiarity, comfort, amusement, and excitement to a micturition trainee. It is further appreciated that the shapes described herein provide an opportunity for interplay between a learning game with the micturition training process and inventive composition. By way of non-limiting example, if a micturition trainee is learning the names of various animals, a parent can promote engagement in the micturition training process and also intermix a learning game by having the micturition trainee successfully name the animal that an inventive composition is shaped as prior to adding the inventive composition to the water in the toilet bowl. The learning game could also illustratively be used to learn numbers, letters, transportation vehicles, tools, planets, etc. It is still further appreciated that an inventive composition formed into shapes as described above, alone or in combination with a learning game, provides another layer of positive micturition training feedback stimulus to the micturition trainee experiencing amusement, excitement, and comfort while interacting with the shapes prior to adding an inventive composition to the toilet water in the toilet bowl. As such, the micturition trainee is even further encouraged to remain engaged with the micturition training process, thereby further increases a micturition trainee's likelihood of success. As still another layer of positive micturition training feedback stimulus, in some inventive embodiments, the composition is effervescent upon addition to the toilet water in the toilet bow through inclusion of an inorganic sodium carbonate, sodium bicarbonate or the like in combination with a dry acid such as citric acid as part of the excipient. It is appreciated that this offers additional amusement stimuli to the micturition trainee who observes the effervescence upon addition of an inventive composition to the toilet water in the toilet bowl.

In an inventive embodiment, a kit for color changing micturition training includes an inventive composition as described herein in a delivery medium, instructions for using an inventive composition during color changing micturition training, and packaging containing an inventive composition in a delivery medium and the instructions.

In some inventive embodiments, the instructions included in the inventive kit also provide directions for locating and viewing an online motivational video that explains to a micturition trainee that water in a toilet bowl will change color after a trainee micturates into the toilet bowl. In inventive embodiments it is appreciated that the online motivational video is a cartoon, Claymation, or other animated visual medium. In other inventive embodiments it is appreciated that the online motivational video includes live actors dressed in costumes oriented towards children illustratively including animal, creature, or abstract being costumes. In still other inventive embodiments, it is appreciated that the online motivational video includes live actors not in costume. In some inventive embodiments, it is appreciated that the online motivational video is in documentary format. In inventive embodiments, it is appreciated that the online motivational video is a blend of cartoon and live acting, as separate segments, as live actors overlaid onto a cartoon backdrop using technology known to the art illustratively including green screen technology, or combinations thereof. It is appreciated that the online motivational video provides yet another positive micturition training feedback stimulus that encourages engagement in the micturition training process by capturing a micturition trainee's attention and instilling excitement and amusement within the micturition trainee upon viewing the motivational video.

An inventive composition is readily stored in glass, metal, or plastic containers made of plastics such as polyethylenes, polypropylenes, nylons, PVC, or PET, or aerosol cans. An invention composition is also readily provided in the inventive kit as a liquid stored in a bottle. It is appreciated that the bottle is optionally equipped with a pump or spray trigger. In embodiments, an inventive composition included in the inventive kit is a liquid and the delivery medium is a dropper bottle. It is appreciated that in some inventive embodiments as little as one drops (about 0.05 ml) of an inventive composition added into the water in a toilet bowl are sufficient to impart a color change upon coming into contact with urine. It is further appreciated that in other inventive embodiments, the observed intensity of the color change upon contact with urine will be directly related to the amount of an inventive composition added into the toilet water in a toilet bowl. In some inventive embodiments, a composition included in the inventive kit is a powder and the delivery medium is a water-dissolvable tablet. In still other inventive embodiments, an inventive composition included in the inventive kit is a gel and the delivery medium is a dissolvable pod formed of a water-soluble polymer such as pectin, carrageenan, algininc acid, amylopectin, polysaccharides such as guar gum, methyl cellulose, ethyl cellulose, hydroxyethyl cellulose, hydroxypropyl cellulose, cellulose derivatives such as carboxymethyl cellulose, polyvinyl alcohol, gelatin, or the like. An exemplary dissolvable pod is detailed in U.S. Pat. No. 6,927,201 B2. It is appreciated that a dissolvable pod operative herein is readily formed with two or more chambers within allowing segregation of various constituents of an inventive composition affording easy manufacture and long-term storage stability. It is further appreciated that segregated constituents of an inventive composition are each a gel, a liquid, a powder, an aqueous solution, or combinations thereof. It is still further appreciated that a dissolvable pod operative herein is also readily used as a delivery medium when an inventive composition included in the inventive kit is a liquid, a powder, an aqueous solution, or combinations thereof. In still other inventive embodiments, an inventive composition included in the inventive kit is a powder and the delivery medium is an enterically coated capsule. In some inventive embodiments, an inventive composition included in the inventive kit is a powder and the delivery medium is a stick pack. In inventive embodiments, it is appreciated that the stick pack is mylar, foil, plastic, or combinations thereof. It is appreciated that in some inventive embodiments the stick pack is impermeable to moisture. In some inventive embodiments, an inventive composition included in the inventive kit is a powder and the delivery medium is a sachet. In inventive embodiments, it is appreciated that the sachet is mylar, foil, plastic, or combinations thereof. It is further appreciated that in some inventive embodiments the sachet is impermeable to moisture. In embodiments where an inventive composition is a powder and the delivery medium is a sachet, it is appreciated that an inventive composition within the sachet is readily delivered into a toilet bowl by opening the sachet and pouring some or all of an inventive composition therein into the toilet bowl. In some inventive embodiments, the sachet is porous as appropriate for the particle size of the particulate making up an inventive composition that is a powder, and as appropriate to achieve the desired rate of release of an inventive composition described as follows. In other embodiments where an inventive composition is a powder and the delivery medium is a sachet, it is appreciated that the sachet is readily affixed to the interior of a toilet bowl, either fully or partially submerged in the standing water in the toilet bowl, thereby continuously delivering an inventive composition into water in a toilet bowl. In still other embodiments, it is appreciated that the sachet is readily affixed to the interior of a toilet bowl, not fully nor partially submerged in the standing water in the toilet bowl, but where it intermittently contacts water being introduced into the toilet bowl to recharge the previous standing water that drains upon flushing the toilet. It is appreciated that affixing the sachet to the interior of a toilet bowl as described herein allows for multiple instances of hands-free introduction of an inventive composition into a toilet bowl over multiple flushes, before the sachet has to either be replaced or refilled, thereby maintaining a toilet bowl in a constant state of readiness to carry out an inventive micturition training process. As the urge to micturate can often manifest suddenly in a child undergoing micturition training, a parent or child does not have to remember and/or hurry to add an inventive composition to a toilet bowl prior to each micturition event, maintaining micturition training consistency, ensuring that a color change occurs every time a micturition trainee urinates into a toilet bowl. In some inventive embodiments, a sachet filled with an inventive composition lasts at least 10 flushes before having to be refilled or replaced. In other inventive embodiments, a sachet filled with an inventive composition lasts at least 50 flushes before having to be refilled or replaced. In still other inventive embodiments, a sachet filled with an inventive composition lasts at least 100 flushes before having to be refilled or replaced. In inventive embodiments, a sachet is an antimicrobial sachet formed from, impregnated or coated with, at least one antimicrobial agent illustratively including: a plant essential oil, a paraben, potassium sorbate, nisin, pediocin, chitosan, a fungicide, polyvinyl chloride (PVC), polypropylene (PP), high density polyethylene (HDPE), low density polyethylene (LDPE), poly(ethylene-co-vinylacetate (EVA), poly(ethylene terephthalate (PET), polyactic acid (PLA), ethylene diamine tetraacetic acid (EDTA), cellulose, lysozyme, microcellular foam starch (MFS), and allyl isothiocyanate (AIT). In other inventive embodiments, an inventive composition is a liquid dispersion and the delivery medium is an aerosol canister. Aerosol propellants operative herein illustratively include difluoroethane, trifluoroethane; alkanes such as butane, pentane, isobutane; propane; ethers such as dimethyl ether and diethyl ether; nitrogen; carbon dioxide; and combinations thereof.

In an embodiment, an inventive process for color changing micturition training includes at least one of reading a motivational booklet or watching an online motivational video, both of which explaining to a micturition trainee that water in the toilet bowl will change color after the trainee urinates into the toilet bowl, motivating the micturition trainee to urinate into the toilet bowl by fostering a positive mental association between anticipation and amusement of watching a color change upon micturating into the toilet bowl, adding an inventive composition as described herein to water in a toilet bowl, micturating into the water in a toilet bowl, observing the color change in the water upon contact with the urine, imparting positive micturition training feedback stimulus to the micturition trainee experiencing amusement and satisfaction upon observing the color change after micturating into the water in the toilet bowl, thereby encouraging regular urination into the toilet bowl and increasing the likelihood of successful completion of micturition training while simultaneously decreasing the total duration of micturition training.

In some embodiments, an inventive composition is effervescent upon addition to the water in a toilet bowl. It is appreciated that the effervescence provides another layer of positive micturition training feedback stimulus to the micturition trainee experiencing further amusement upon observing the effervescence, thereby further encouraging engagement of the micturition trainee with the inventive color changing micturition training process. In other inventive embodiments, the online motivational video also explains to a micturition trainee that an inventive composition will effervesce upon addition to water in a toilet bowl, building further anticipation in a micturition trainee and instilling an eagerness to engage in embodiments of the inventive color changing micturition training process.

In embodiments, an inventive composition also includes a second color changing indicator that changes from an initial color to a second color upon contact with the water in a toilet bowl, with the proviso that the second color is a color different than the second color of the color changing pH indicator. It is appreciated that the second color changing indicator provides another layer of positive micturition training feedback stimulus to the micturition trainee experiencing further amusement upon observing the color change of the water in the toilet bowl upon adding an inventive composition therein. Is if further appreciated that the second color changing indicator thereby further encourages engagement of the micturition trainee with the inventive color changing micturition training process. In some inventive embodiments, the online motivational video and the motivational booklet also explain to a micturition trainee that an inventive composition will change color upon addition to water in a toilet bowl, building further anticipation in a micturition trainee and instilling a further eagerness to engage in embodiments of the inventive color changing micturition training process.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

1. A process of toilet training a subject to encourage urination in a toilet comprising:
adding urease and color changing first pH indicator into water a toilet bowl of the toilet;
in the presence of urine in the water allowing sufficient time for urease to react with the urine to create a by-product that causes the color changing first pH indicator to change to a second color at a first pH thereby encouraging the subject to urinate in the toilet.

2. The process of claim 1 wherein the urease and color changing first pH indicator are added from a premixed composition.

3. The process of claim 1 wherein the urease and color changing first pH indicator are added as a liquid.

4. The process of claim 1 wherein the urease and color changing first pH indicator are added as a powder, tablet, or gel.

5. The process of claim 1 further comprising showing the subject at least one of a motivational video or booklet to encourage to urinate in the toilet.

6. The process of claim 5 wherein the showing of the motivational video or booklet precedes adding the urease and the color changing first pH indicator into water.

7. The process of claim 1 further comprising adding a color changing second pH indicator to the water to change the color changing second pH indicator to a second color at a second pH higher than that first pH, with the proviso that the second color of the color changing second pH indicator is different than the second color of the color changing first pH indicator.

8. A kit for color changing micturition training comprising:
a composition comprising urease, a color changing first pH indicator, and an excipient; and
instructions for using the composition during toilet training.

9. The kit of claim 8 wherein the instructions further comprise at least one of a motivational booklet or directions for locating and viewing an online motivational video, the motivational booklet and the online motivational video explaining to a subject that water in a toilet bowl will change color in the presence of the composition after the subject urinates into the toilet bowl.

10. The kit of claim 8 wherein the composition is a liquid and further comprising a container for the composition that is a dropper bottle.

11. The kit of claim 8 wherein the composition is in a form of a dry powder and further comprising a container for the composition that is a stick pack or a sachet.

12. The kit of claim 8 wherein the composition is in a form of a water-dissolvable tablet.

13. A composition comprising:
a urease; and
a color changing first pH indicator; and
an excipient comprising citric acid, a binder, or a combination thereof.

14. The composition of claim 13 wherein the color changing first pH indicator changes to a first color at a pH range of between 5 and 8.5.

15. The composition of claim 13 further comprising a color changing second pH indicator.

16. The composition of claim 13 wherein the color changing first pH indicator is at least one of: carminic acid, curry powder, thymol blue, pentamethoxy red, tropaeolin O, tropaeolin OO, tropaelin OOO, alizarin sodium sulfonate, alpha-naphthyl red, para-ethoxychrysoidine, bromocresol green, methyl red, bromocresol purple, chlorophenol red, bromothymol blue, para-nitrophenol, azolitmin, phenol red, neutral red, rosolic acid, cresol red, naphtholphthalein, phenolphthalein, naphtholbenzein, thymolphthalein, nile blue, alizarin yellow, salicyl yellow, diazo violet, nitramine, poirrier's blue, trinitrobenzoic acid, extracts from: beets, blackberries, blueberries, carrots, cherries, delphinium petals, geranium petals, grapes, grape seeds, horse chestnut leaves, morning glories, pansy petals, petunia petals, primrose, poppy petals, purple peonies, red radish, red cabbage, rhubarb, rose petals, strawberries, tea, turmeric, tulip petals, thyme, violet petals, or vanilla.

17. The composition of claim 13 wherein the citric acid is present and in the form of citric acid monohydrate.

18. The composition of claim 13 further comprising a dessicant.

19. The composition of claim 13 wherein the binder is present and formed into a water-dissolvable tablet or a water dissolvable pod with a fanciful shape as at least one of: an animal, a plant, a flower, food, clothing, a cartoon character, a fictional character, a letter, a number, an automobile, a truck, an airplane, a boat, a train, a bicycle, a wagon, a toy, a ball, a hammer, a geometric shape, a planet, a star, or a musical instrument.

20. The composition of claim 13 further comprising an effervescent carbonate.
